(19) United States
(12) Patent Application Publication
(10) Pub. No.: US 2020/0124847 A1
(43) Pub. Date: Apr. 23, 2020

(54) HEAD'S UP DISPLAY WITH MICRO-OPTICAL COMBINER

(71) Applicants: Esteban Arboix, Sundbyberg (SE); Ilkka Alasaarela, Kuusamo (FI)

(72) Inventors: Esteban Arboix, Sundbyberg (SE); Ilkka Alasaarela, Kuusamo (FI)

(21) Appl. No.: 16/656,333

(22) Filed: Oct. 17, 2019

Related U.S. Application Data
(60) Provisional application No. 62/746,954, filed on Oct. 17, 2018.

(51) Int. Cl. G02B 27/01; B60K 35/00

(52) U.S. Cl. CPC G02B 27/0101; B60K 35/00; G02B 2027/0196; B60K 2370/1529; G02B 2027/013; G02B 27/0189

(57) ABSTRACT

A device for a head's up display comprises a picture generating unit; a projector optics; and a combiner. The combiner comprises a substrate made of optically transparent material and micro-optical structures arranged in a discrete array. The picture generating unit is arranged to deliver a beam of light, containing an image, to the projector optics. The projector optics and the combiner are arranged to form a virtual image of the image by reflecting a portion of the beam from the micro-optical structures. In the reflection, for at least a part of the beam reflected from the micro-optical structure, the resulting reflection deviates from the hypothetical reflection from the extrapolated substrate surface.

### CROSS REFERENCE TO RELATED APPLICATION

This application claims priority to U.S. Provisional Application Ser. No. 62/846,954, filed on Oct. 17, 2018 and entitled “Head's up display combiner”, the contents of which are incorporated by reference herein in its entirety.

### TECHNICAL FIELD

The teachings herein relate generally to head's up displays, and particularly to head's up displays for off-highway vehicles.

### BACKGROUND

Typical problem with head's up displays (HUDs) is small field-of-view (FOV) and small eye-box (EB) size. This problem becomes particularly severe in off-highway vehicles (OHV) where FOV and EB requirements are particularly large, such as tractors, combine harvesters and forestry harvesters, for example.

Conventional solutions for increasing FOV and EB are to use curved combiner (U.S. Pat. No. 7,095,562B) or holographic combiner (JP2011201352A) or use of very large optics. However, these solutions are not desirable, as typical OHV cabins are limited in space, and curved or holographic combiners are precision components which are not easily integrated with the windshield.

Another typical problem with HUDs is that the combiner needs to be mounted in a specific position or angle to obtain optical functionality, which takes large amount of space from the cabin, or is disturbing the movements of the operator.

Optimal HUD has large FOV and ER, is small in size, has good image quality, and has a combiner integrated with the cabin windshield, or has combiner which takes only small amount of space from the cabin and is not disturbing the operator.

The present invention seeks to overcome at least some of the above difficulties and undesirable tradeoffs.

### SUMMARY

According to an exemplary embodiment of the invention there is a device for a head's up display, the device comprising:
a picture generating unit;
a projector optics; and
a combiner comprising:
a substrate made of optically transparent material; and
micro-optical structures arranged in a discrete array,

In this embodiment the picture generating unit is arranged to deliver a beam of light, containing an image, to the projector optics. The projector optics and the combiner are arranged to form a virtual image of the image by reflecting a portion of the said beam from the micro-optical structures. In said reflection, for at least a part of the beam reflected from the micro-optical structure, the resulting reflection deviating from the hypothetical reflection from the extrapolated substrate surface.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 presents a schematic diagram of a head's up display according to the invention.

FIG. 2 shows combiner according to the invention, comprising micro-optical prisms.

FIG. 3 shows an arrangement of a micro-prism on a substrate.

FIG. 4 shows another arrangement of a micro-prism on a substrate.

FIG. 5 shows still another arrangement of a micro-prism on a substrate.

FIG. 6 shows another arrangement of a micro-prism on a substrate.

FIG. 7 shows an arrangement of micro-prisms laminated between two substrates.

FIG. 8 shows micro-prisms arranged in a discrete array.

FIG. 9 shows a combiner use in projector-down configuration.

FIG. 10 shows a combiner use in projector-up configuration.

FIG. 11 shows a combiner use in projector-up configuration.

FIG. 12 shows a micro-prism on a substrate.

### DETAILED DESCRIPTION

The advantages of the present invention include, without limitation, the following:
Large field-of-view
Large eye-box size
Combiner integrated with vehicle windshield
Small optics size
Easier integration of HUD with OHV cabins
Better HUD image quality
Suitability for mass production
HUD optics and combiner are lighter in weight
Non-fragility of HUD combiner

Referring now to the invention in more detail, in FIG. 1 there is shown a schematic diagram of a HUD of the invention, comprising a picture generating unit (100), HUD projector optics (102), and a combiner (104). The picture generating unit (PGU) (100) contains one or more light sources. The PGU (100) by using that light forms a beam of light and implicitly an image (image source). The HUD projector optics (102) projects at least portion of the beam to the combiner (104), which reflects at least a portion of the beam towards the observer (105), who is typically an operator of the machine. The projector and combiner together form a HUD visualization means which creates a virtual image (108) of the said image source to approximately few meters distance from the observer. The distance from the observer (105) to the virtual image (108) can vary for example between 0.5 meter and infinity, typically between 2 m and 10 m.

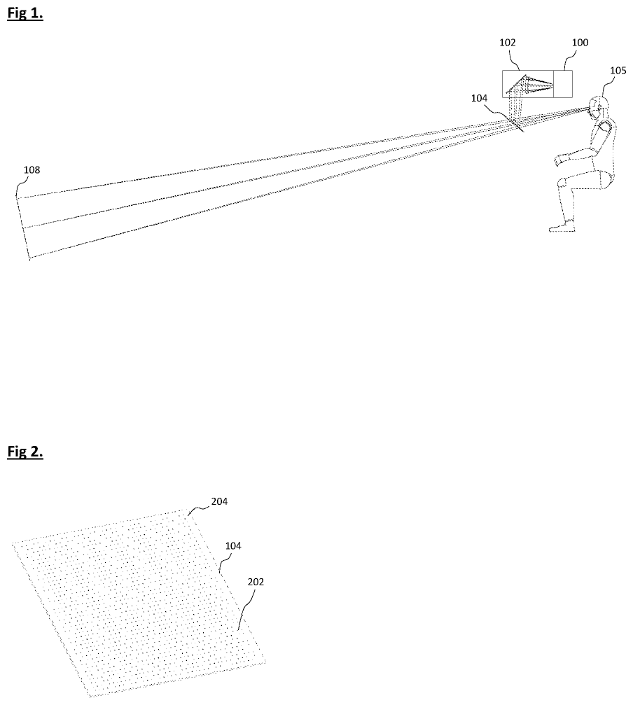

FIG. 2 shows a combiner (104) of the invention comprising micro-optical structures (202). The combiner consists of optically transparent substrate (204), such as plastic film or sheet plate, with small micro-optical structures (202) on it. The structures may be created at the same time with the forming of the substrate (204), for example by injection molding, or hot-embossing, or afterwards for example by roll-to-roll printing, embossing or micro-machining. The thickness of the substrate (204) may be in the range of for example from 0.02 mm to 10 mm, or for example from 0.5 to 5 mm. The micro-optical structures (202) may be arranged to both sides of the substrate (204), or to only one side. Combiner (104) material can be for example plastic polymer, such as PC, PMMA, COC, or Polystyrene for example, or glass. Micro-structures (202) may also be made of different material than the substrate (204). Micro-structures (202) may be embossed on the substrate (204) by UV-resin.

Micro-optical structures are micro-sized structures, such as micro-scale prisms, grooves, notches, pyramids, wedges, etc. which has at least one facet whose surface direction deviates from the surface direction of the substrate, and so is able to provide reflection by that facet to a different angle than from the substrate. The facet of facets used for reflecting the light can also be curved. There may be one or two, or even more, reflections per micro-structure, depending on what is the most effective way to bend light into the desired direction. The reflection may be based for example on partial reflection from micro-prism surface optical interface, or on total-internal-reflection from air interface, or reflection from mirror-coated or thin-film coated micro-prism surface, depending on most effective method in each position on the combiner surface.

Advantages of these micro-optical structures are suitability for mass-production, good efficiency and contrast, for example, when compared to diffractive or holographic structures. The width of the facets of the micro-optical structures along the substrate surface may vary for example between 2 and 2000 micrometers, or more particularly between 20 and 400 micrometers. The height of the micro-optical structure facets may vary for example between 1 and 2000 micrometers, or more particularly between 10 and 400 micrometers, in direction perpendicular to substrate surface.

The purpose of the combiner is to reflect predetermined part of the light arriving from the HUD visualization means to the observer, while being substantially transparent so that observer can see through the combiner substantially unobscured way. Another purpose of the combiner is to form the virtual image of the image source as a part of the HUD visualization means to a predetermined location, by combining and merging the HUD virtual image to the see-through scenery. In addition, the combiner of the invention is capable to perform optical function to the reflected light, similar to for example curved mirror or lens, by the described micro-optical structures. The described structures allow specifying the optical function very freely, so that the combiner can work for example as convex or concave mirror, which can have spherical, aspherical, biconic, cylindrical or freeform optical function.

Existing curved combiners have severe disadvantage coming from the geometrical domain: their base shape (i.e. substrate form) defines the optical function. Even Fresnel lenses have the same limitation because of the continuity requirement along the fringes. This causes severe limitations how the combiner and the whole HUD system can be integrated to the cabin.

The combiner of the invention is advantageous in that the optical function is defined by the micro-structures and not by the substrate shape. This makes the cabin integration much easier, and for example allows larger FOV and larger EB in smaller space.

Some embodiments of the invention contain micro-optical prisms structures on a substrate. The following figures show exemplary cross-sections of some micro-optical prisms used in some HUD combiners of the invention.

Projector-up configuration means that the HUD visualization means reflects the image towards the observer from substantially above the eye-box, whereas projector-down configuration means that the image is reflected from substantially below the eye-box. In some embodiments of the invention the image may be reflected towards the observer from substantially the same vertical position than the eye-box, which may be interpreted as either projector-up or projector-down configuration.

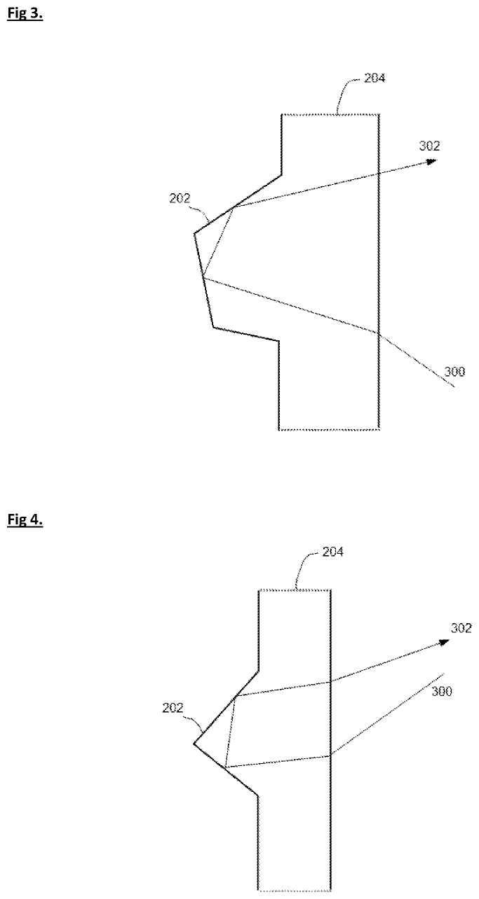

FIG. 3 shows an arrangement of a micro-prism (202) on a substrate (204) in a combiner to be used in projector-down configuration. Ray (300) is arriving from the HUD visualization means, gets reflected twice in micro-optical prism (202), and ends up as a ray (302) propagating towards the eye-box.

FIG. 4 shows another arrangement of a micro-prism (202) on a substrate (204) in a combiner to be used in projector-up configuration. Ray (300) is arriving from the HUD visualization means, gets reflected twice in micro-optical prism (202), and ends up as a ray (302) propagating towards the eye-box.

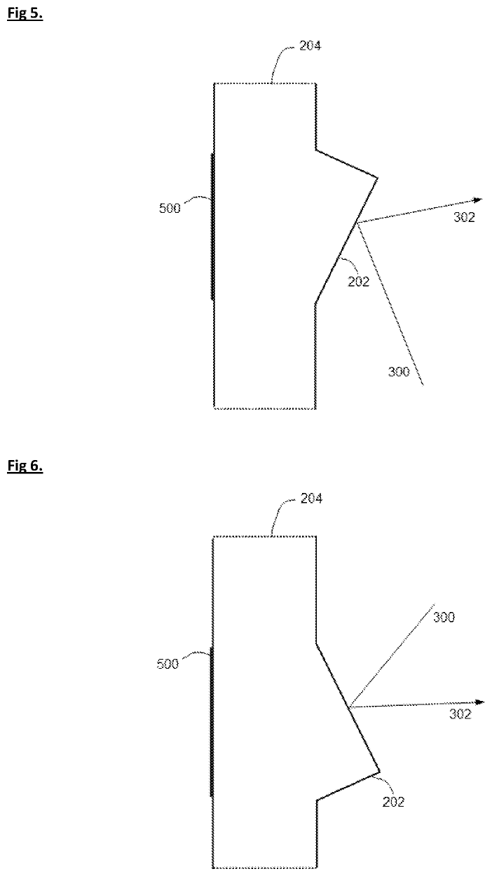

FIG. 5 shows still another arrangement of a micro-prism (202) on a substrate (204) in a combiner to be used in projector-down configuration. Ray (300) is arriving from the HUT) visualization means, gets reflected from micro-optical prism (202), and ends up as a ray (302) propagating towards the eye-box. Furthermore, there is a masked area (500) behind the micro-prism (202) in order to prevent the ambient light transmitting through the micro-prism and forming ghost image distorting the virtual image.

As shown in FIG. 5, there may be non-transparent mask (500) on the back side of the substrate (204). Mask can be a metal coating for example, or rough surface treatment, which prevents direct transmission through the masked area.

FIG. 6 shows still another arrangement of a micro-prism (202) on a substrate (204) in a combiner to be used in projector-up configuration. Ray (300) is arriving from the HUD visualization means, gets reflected from micro-optical prism (202), and ends up as a ray (302) propagating towards the eye-box. There is masked area (500) behind the micro-prism (202) in order to prevent the ambient light transmitting through the micro-prism and forming ghost image.

FIG. 7 shows micro-prism structures (202) laminated between two glass substrates (700). In some other embodiments, there could be polymer substrates instead of the glass substrates. Prism surfaces (702) are made visible by arranging an airgap (704) behind the prism surfaces (702). Airgap (704) can be arranged by a rough counterpart surfaces (706), which arrangement leaves some air between the two polymer layers (708) and so enables total-internal-reflection (TIR) based reflection. The rough surfaces (706) may be coated with a non-transparent coating in order to prevent ambient light from scattering from the rough surface (706) towards the eye-box. Instead using TIR-reflection by help of airgap (704) and rough surfaces (706), prism surfaces (702) could be coated with at least partially reflective or dichroic coating. Instead of two or more reflecting surfaces per prism, it can be advantageous to have only one at least partially reflective surface per prism, the other surface or surfaces being substantially non-reflecting, i.e. transmissive, after lamination.

The reflecting micro-prism surfaces (702) can be coated by a thin-film coating or dichroic coating so that they are reflecting on only one or few bands of visible spectrum, or so that the reflection is enhanced or suppressed at one or few bands.

By adjusting the exact shape and directions of the prism surfaces (702), the direction of the reflected tight can be precisely adjusted.

The micro-prisms (202) can be arranged in an array to the same transparent substrate (204, 708). The array may be a discrete array, where large portion of transparent substrate is prism-free. By discrete array we mean an array of separate micro-structures. When micro-structures are separate, they share only the same substrate, or the same substrates, and they have no other common facets.

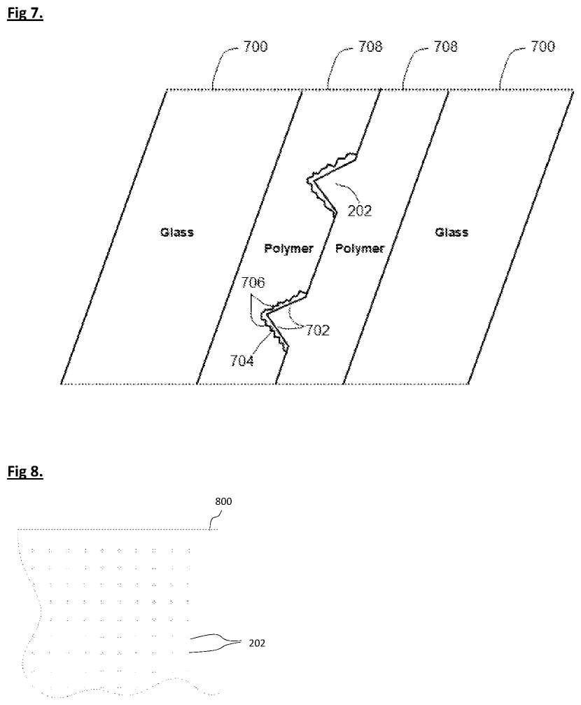

FIG. 8 shows an embodiment of the invention, where micro-prisms (202) are arranged in a discrete array arrangement, where most of the surface area of the combiner is operating as a normal window (800), and portion of the surface area is occupied by reflecting micro-optical structures (202). Micro-optical structures (202) can be arranged in two-dimensional matrix, which is not necessarily rectangular, but can be an array of any shape. The array need not to be periodic, symmetric, or any systematic arrangement, but it can be any made to purpose non-periodic, asymmetric, quasi-random distribution of micro-structures on the substrate.

In this kind of discrete array arrangement by adjusting the distance between the prisms and the size of the prisms, the portion of the light transmitted unobscured through the transparent substrate can be adjusted and correspondingly the portion of the light which is reflected to the eye-box can be adjusted.

The advantage of the described discrete array arrangement is that its operation does not necessarily require thin-film or dichroic coatings which reflect different portions of the visible spectrum with different reflectance, but the discrete array arrangement may work substantially equal efficiency through the substantially whole visible range ranging from approximately 400 nanometers to approximately 700 nanometers.

Another advantage of the discrete array arrangement is that the most of the combiner area may be free of micro-structures, which ensures good see-through image quality.

The spacing of the micro-structures may be selected to be substantially smaller than size of the light beam which is arriving through the eye pupil of the observer. The spacing may be for example between 10 and 3000 micrometers, or between 50 and 1000 micrometers more particularly. This may make the micro-structures substantially invisible to eye in normal operation when the eye is focused to the virtual image.

The above described micro-prisms can be used to guide light to the desired direction. When micro-prisms are arranged in array form, their ray-guiding properties can be arranged so that it resembles function of a curved mirror. This kind of arrangement is free of many restrictions of continuous surfaces, or even restrictions of grooved Fresnel lens forms. As the micro-structures are separate, their shape can vary freely over the substrate.

This discrete micro-prism array works as a beam-splitter, which passes large portion of the beam through the array unchanged and reflects the other portion of the beam With desired manner. For the reflected portion of the beam, the film is a reflective mirror with optical function such as optical power for example. The reflective mirror can resemble operation of an aspherical mirror, cylindrical mirror, elliptical mirror, biconic mirror or any form or combination of them just by varying the aforementioned prism surface orientations in different portions of the discrete array.

The optimal arrangement of micro-structures may be circular instead of rectangular, too, depending on the desired optical function.

The described discrete array of micro-prism structures can be manufactured on a rigid substrate, or on a flexible film which can be attached to a rigid substrate such as planar combiner substrate or windshield for example.

This new kind of component, discrete micro-prism array film, can be used as a combiner in a HUD in the following ways.

FIG. 9 shows how the combiner (104) reflects the beam from HUD projector optics (102) located below the combiner (104) towards the eye-box (900), where the observer (105) views the HUD image. That is projector-down configuration. The prism array has no optical power, but the reflection direction is different than substrate direction. By that way the combiner can be integrated with the windshield, and windshield angle does not need to be matched with HUD projector (102) and the eye-box (900), but the matching can be done by the combiner (104). Matching here means the arrangement that the windshield surface direction needs to provide mirror reflection from HUD projector to the eye-box. With the combiner (104) of the invention the windshield surface direction, i.e. the substrate surface direction, may be different than what mirror reflection would require.

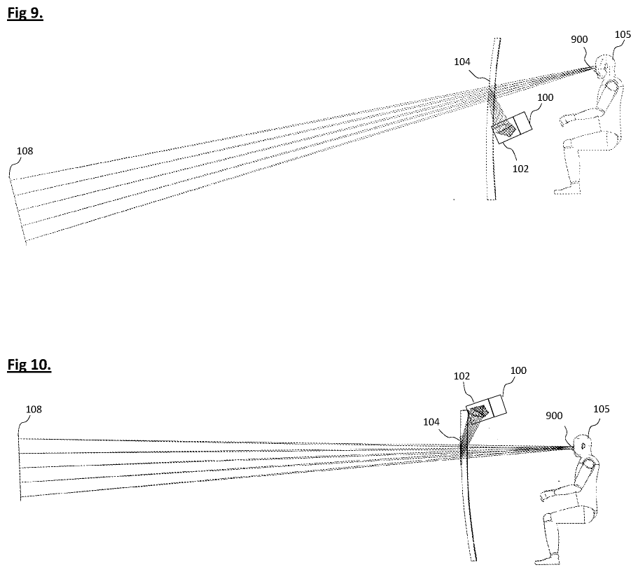

FIG. 10 shows how the combiner (104) reflects the beam from HUD projector optics (102) located above the combiner (104) towards the eye-box (900). That is projector-up configuration. In addition to the change to the reflection direction, the combiner (104) has optical power. By the optical power, the FOV of the HUD can be arranged very large compared to FOV with combiner without the optical power.

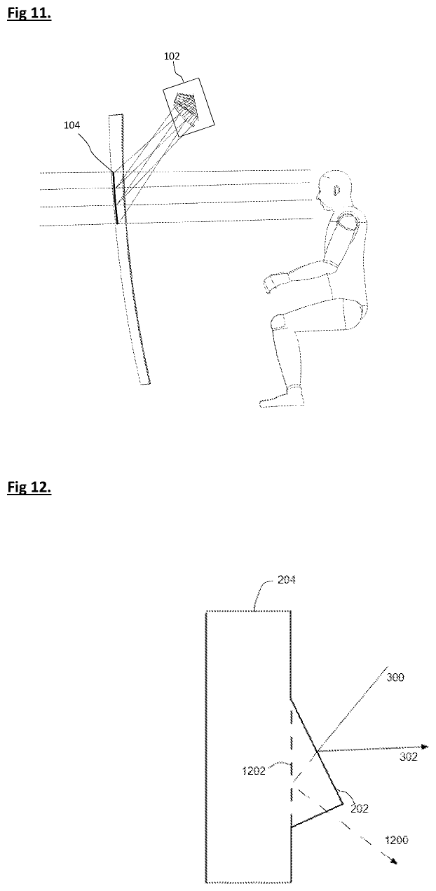

Due to the optical power, a real image of the image source may be formed between the projector unit and the combiner. FIG. 11 shows how the large field-of-view arranged by the combiner (104) may not necessarily be wholly used at a time, but the HUD projector unit (102) may project image to a part of the large field-of-view, which enables higher resolution than when projecting whole field-of-view at a time. The projected image position may be varied by tilting or rotating or translating one or more mirrors for example.

FIG. 12 shows the nature of the micro-structure (202) function and the difference between the micro-structure (202) reflected ray (302) compared to the hypothetical arrangement without the micro-structure (202) where incoming ray (300) reflects from the extrapolated substrate surface (1202). The dashed line shows the extrapolated substrate surface (1202) on the micro-structure (202) location. Furthermore, the ray (1200) drawn by the dashed line, shows how the ray (300) would reflect from the extrapolated substrate surface (1202) in the non-existing case. The direction of the micro-structure reflected ray (302) deviates from the direction of the ray (1200) reflected from the extrapolated substrate surface (1202). Although drawn planar in the FIG. 12, the substrate (204) may as well be curved, in the case of which the extrapolated substrate surface may be curved, too.

Although described in the context of particular embodiments, it will be apparent to those skilled in the art that a number of modifications and various changes to these teachings may occur. Thus, while the invention has been particularly shown and described with respect to one or more preferred embodiments thereof, it will be understood by those skilled in the art that certain modifications or changes may be made therein without departing from the scope and spirit of the invention as set forth above, or from the scope of the ensuing claims.

What is claimed is:

1. A device for a head's up display, the device comprising:
a picture generating unit;
a projector optics; and
a combiner,
said combiner comprising:
a substrate made of optically transparent material; and
micro-optical structures arranged in a discrete array,
wherein:
the picture generating unit is arranged to deliver a beam of light, containing an image, to the projector optics;
the projector optics and the combiner are arranged to form a virtual image of the image by reflecting a portion of the said beam from the micro-optical structures;
in said reflection, for at least a part of the beam reflected from the micro-optical structure, the resulting reflection deviating from the hypothetical reflection from the extrapolated substrate surface.

2. The device of claim 1, wherein the head's up display is mounted in an off-highway vehicle.

3. The device of claim 2, wherein the combiner is integrated with a windshield.

4. The device of claim 1, wherein the micro-optical structures are micro-prisms.

5. The device of claim 1, wherein the micro-optical structures are laminated between two substrates.

6. The device of claim 1, wherein the micro-optical structures are laminated inside windshield.

7. The device of claim 1, wherein the micro-optical structures cover less than 20% of the substrate area illuminated by said beam.

8. The device of claim 1, wherein the head's up display is mounted in a machine cabin.
